(19) United States
(12) Patent Application Publication
(10) Pub. No.: US 2008/0263779 A1
(43) Pub. Date: Oct. 30, 2008

(54) Release compositions and their application to textiles

(75) Inventors: Bradley W. McClanahan, Mooresville, NC (US); Vita A. Dean, Fort Mill, SC (US); Roberta Neely Altman, Dallas, NC (US)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International, Ltd.

(21) Appl. No.: 11/796,481

(22) Filed: Apr. 27, 2007

(51) Int. Cl. D06M 13/395; C08G 18/00; D06M 13/398

(52) U.S. Cl. 8/115.7; 525/125; 8/115.51; 8/115.67

(57) ABSTRACT

The present invention is directed to a treatment composition for polyester and polyester blends including a hydrophilic copolymer and a hydrophilic, reactive polyurethane and the process for treating the textile material. When the treatment composition is applied to a textile which is 100% cellulosic textile material, the treatment composition includes at least one fluorochemical copolymer and at least one hydrophilic reactive polyurethane. In both cases, the treated textile material exhibits both increased oil and grease absorbance and good rinsing properties.

### FIELD OF INVENTION

The invention is directed generally to release compositions and their application to textiles, and in particular, to oil and grease release compositions.

### BACKGROUND OF THE INVENTION

The absorption of grease and water is a common problem faced on a daily basis in industrial, commercial and residential settings. In all of these settings, the task is to remove oil and grease from a floor or other surface that is exposed to human contact. Failure to effectively remove grease and oil from such surfaces creating a potentially hazardous condition and, additionally, in commercial and residential settings, results in an unappealing visual appearance.

Normally, to remove oil or grease from a surface, a textile material, is applied to the oil or grease containing area. The textile is then rinsed by applying or immersing the textile into water or an aqueous cleaning solution to remove the oil or grease absorbed by the material. The material is then wrung or otherwise has the excess water or aqueous solution removed therefrom, and the process is repeated. Each successive step of removing the water or aqueous cleaning solution from the material results in less oil or grease being extracted or removed from the textile, thereby reducing the efficacy of cleaning process as the textile is capable of absorbing less and less oil or grease. In consequence, either the surface is not rid of the oil or grease or the operator is forced to replace the textile. Neither outcome is acceptable for if oil or grease remains on a surface, the potential exists for a hazardous condition. If the textile is replaced, economic costs are invariably increased.

In addition, as is common knowledge, textile garments are susceptible to tarnishment by oil and grease. When the oil or grease can not be removed by normal washing, the garment may lose its aesthetic appeal or be ruined entirely.

In consequence, there exists a need for a release composition, that, when applied to a textile effectively releases the oil or grease absorbed by the material.

### SUMMARY OF THE INVENTION

According to its major aspects and briefly stated, the invention is directed a treatment composition that increases the oil and grease release properties of a textile to which it is applied. The treatment composition for synthetic or a composite synthetic material includes at least one hydrophilic polyester copolymer and at least one hydrophilic reactive polyurethane. When the treatment composition is applied to a textile which is 100% cellulosic textile material, the treatment composition includes at least one fluorochemical copolymer and at least one hydrophilic reactive polyurethane. In both cases, the treated textile material exhibits both increased oil and grease absorbance and good rinsing properties. As such, the treated textile, is highly useful for applications where it will be used to absorb oil or grease materials, rinsed and wrung out, and reused, such as for example, the food service industry.

In addition, the treatment composition of the present invention, due to its oil and grease release properties finds application in all textile garments, such as, for example, pants, shirts and the like. The ability of garments treated with the treatment composition of the present invention to easily release oil and grease during normal washing increases the garment's longevity as well as its aesthetic appeal.

These and other advantages and features of the invention will become apparent upon review of the following specification.

### DETAILED DESCRIPTION OF THE PREFERRED EMBODIMENTS

This invention relates to a treatment composition that imparts oil- and grease absorbency and release properties to textiles treated therewith and a method of treating the textiles.

The textile material treated by the composition of the present invention not only demonstrates high absorbency for oils and greases and water but also has the ability to easily release such oils, greases and water upon application of moderate pressure at ambient temperatures. The increased abilities afforded the treated textile are suited for all commercial, industrial and residential applications wherein effective removal of oil and grease are required. The present invention finds particular application in the food service industry utilizing wipes and mops, wherein the cooking area requires consistent cleaning to control grease and oil to combat slips and falls and ensure sanitary cooking surfaces.

Additionally, a treated textile, in accordance with the present invention, may be used to form, or may be combined with other fabrics or components in the construction of garments, wherein the ability to absorb and subsequently release grease and oil at ambient temperatures is a useful property.

The textile material for use in conjunction with the present invention can be synthetic, cellulosic or a composite thereof. Furthermore, the textile may be non-woven, woven or knitted fabric, or a yarn and includes polyester, and cotton, as well as blends, for example, polyester/cotton. Both white and colored (printed, dyed, yarn-dyed, cross-dyed, etc.) fabrics and yarns can be effectively treated with the composition and method of the invention.

The cellulosic material that can be used in conjunction with the present invention may be cotton, rayon, linen, hemp, and bamboo.

The treatment composition for treating polyester and polyester blends, according to the present invention is a hydrophilic copolymer mixture comprising at least one hydrophilic polyester copolymer and at least one hydrophilic reactive polyurethane.

Preferably, the at least one hydrophilic polyester copolymer has repeating segments of ethylene terephthalate units-containing 10-50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the polymeric compound is between 2:1 and 6:1.

Compounds useful as hydrophilic reactive polyurethanes are based on polyoxyethylene segment containing polyols or polyamines or mixture of them and polyisocyanates, with at least one blocked isocyate group per molecule, preferably based on polyoxyethylene segment containing polyols and aliphatic polyisocyanate. Molecular weight from 2000 to 200'000. The at least one hydrophilic reactive polyurethane preferably has a molecular weight of from 2,000 to 20,000.

The at least one hydrophilic polyester copolymer is present in the range of from 1 percent to 15 percent, preferably from 3 percent to 12 percent and most preferably from 5 percent to 10 percent, based on the weight of the goods. The at least one hydrophilic reactive polyurethane is present in the range of from 1 gram per liter to 30 grams per liter preferably from 5 grams per liter to 20 grams per liter and most preferably from 7.5 grams per liter to 15 grams per liter in the treatment bath.

The usefulness of the treatment composition of the present invention lies, in part in its ability to impart oil- and grease-release characteristics to a textile during washing or rinsing, thus facilitating the removal of stains from mops, napkins, tablecloths, pants, shirts, etc., thereby extending their useful life, and to enhance the ability of the treated textile material to shed oil and grease. The term oil- and grease-release denotes the ease with which oil or grease is removed from a stained or soiled textile, once washed or rinsed.

Thus the present invention further relates to a method to impart oil-release and oil release characteristics to a textile material, which comprises applying to the textile material an effective amount of the treatment composition according to the invention

The step of applying may be conducted by an exhaust application wherein a textile is immersed in a bath including the treatment composition of the present invention at a particular temperature and pH. The temperature of the batch is maintained at approximately 150° F. to 250° F., preferably from 160° F. to 220° F. and most preferably 170° F. to 185° F. The pH of the bath is in the range of 3.5 to 7.0, preferably 4.0 to 6.5 and most preferably, from 5.0 to 5.5.

Alternatively, the step of applying can be by a continuous process. In the continuous process, the polyester/cotton yarn is padded with an aqueous liquor containing 87.5 g/l of HYDROPERM® T and 12.5 g/l of HYDROPERM® RPU and 0.5 g/l Acetic Acid to a wet pick-up of 70 to 80% based on the weight of the dry substrate, then predried for 4 minutes at 140° C., and heatset for 1 minute at 170° C. By this method, the polyester/cotton yarn displayed satisfactory results in the oil release test.

One embodiment of the present invention is the process for treating a hank of polyester/cotton yarn. The 20 gram hank of polyester/cotton yarn is introduced into 250 ml AHIBA© Polymat can, which contains 200 ml of water at 120° F. Subsequently, 7% owg HYDROPERM® T, 0.5 g/l Acetic Acid and 2 g/l IMACOL® ACA are added to the liquor, and the liquor is heated to 175° F., at a rate of 3° F./min, and treatment is continued at 175° F. for 45 minutes in a AHIBA© Polymat laboratory machine. The liquor is then discharged from the AHIBA© Polymat can. The AHIBA© Polymat can is the refilled with 200 ml water at approximately 120° F. and 1 g/l HYDROPERM® RPU. The liquor is held at 120° F. for 5 minutes. The liquor is then discharged from the can, the hank of yarn is unloaded, the liquor is extracted from the yarn, and the yarn is dried. A polyester/cotton yarn having a very good oil and grease release is obtained.

A further embodiment of the present invention is a composition and process for treating 100% cellulosic textile material. The treatment composition for treating cellulosic textile material, according to the present invention, is a mixture comprising at least one fluorochemical copolymer and at least one hydrophilic reactive polyurethane.

Compounds useful as the fluorochemical copolymer are any of the perfluoroalkyl ester copolymers, preferably a perfluoroalkyl ethyl acrylate ester copolymer.

Compounds useful as hydrophilic reactive polyurethanes are based on polyoxyethylene segment containing polyols or polyamines or mixture of them and polyisocyanates, with at least one blocked isocyate group per molecule, preferably based on polyoxyethylene segment containing polyols and aliphatic polyisocyanate. The molecular weight is from 2000 to 200,000. The at least one hydrophilic reactive polyurethane preferably has a molecular weight of from 2,000 to 20,000.

The at least one fluorochemical copolymer is present in the range of from 10 grams per liter to 150 grams per liter, preferably from 30 grams per liter to 120 grams per liter and most preferably from 50 grams per liter to 10 grams per liter in the treatment bath. The at least one hydrophilic reactive polyurethane is present in the range of from 1 gram per liter to 30 grams per liter preferably from 5 grams per liter to 20 grams per liter and most preferably from 7.5 grams per liter to 15 grams per liter in the treatment bath.

The following non-limiting examples disclose the inventive copolymers and describe in detail methods of their application to various substrates. They also demonstrate the good performance of the copolymers on the various substrates.

### EXAMPLE 1

### Exhaust Application to a Yarn

A hank of polyester yarn was treated as follows: in a Polymat laboratory machine, 20 grams of polyester yarn were introduced into 250 ml Polymat can, containing 200 ml of water at 120° F. Seven percent (7%) owg HYDROPERM® T, 0.5 g/l Acetic Acid and 2 g/l IMACOL® ACA were added to the liquor, and the liquor was heated to 175° F., at a rate of 3° F./min. The treatment was continued at 175° F. for 45 minutes. The liquor was then discharged. The Polymat can was then refilled with 200 ml water at approximately 120° F. and 1 g/l HYDROPERM® RPU. The liquor was held at 120° F. for 5 minutes. Thereafter, the liquor was discharged from the can and the goods unloaded. The liquor was then extracted from the yarn, and the yarn dried. A polyester yarn having a very good oil and grease release is obtained, as evidenced by the results of the oil release test.

### EXAMPLE 2

The methodology of Example 1 was carried out on a hank of polyester/cotton yarn. A polyester/cotton yarn having a very good oil and grease release is obtained, as evidenced by the results of the oil release test set forth in Table 2.

### EXAMPLE 3

### Continuous Application to Yarn

A cotton yarn was padded with an aqueous liquor containing 87.5 g/l of NUVA® SRCN and 12.5 g/l of HYDROPERM® RPU and 0.5 g/l Acetic Acid to a wet pick-up of 70 to 80% based on the weight of the dry substrate, then predried for 4 minutes at 140° C., and heatset for 1 minute at 170° C. By this method, the cotton yarn displayed satisfactory results in the oil release test. See Table 1.

### EXAMPLE 4

### Exhaust Application to Fabric in a Jet Machine

Polyester/cotton fabric was treated in a jet at a liquor/substrate ratio of 5:1 to 10:1 with an aqueous liquor containing 7% owg HYDROPERM® T, 0.5 g/l Acetic Acid and 2 g/l IMACOL® ACA, at a pH of 5.5. The bath was heated to 175° F., at a rate of 3° F./min, and treatment continued at 175° F. for 45 minutes. Thereafter, the jet was refilled with water at approximately 120° F. and 1 g/l HYDROPERM® RPU. The bath was held at 120° F. for 5 minutes, followed by rinse, cooling, unloading and drying. A polyester/cotton fabric having a very good oil and grease release was obtained.

### EXAMPLE 5

Exhaust application to mops in a split pocket machine. A split pocket machine was filled with 400 pounds of polyester/cotton mops. The split pocket machine was filled with 431 gallons of water (120° F.). Thereafter, 7% owg HYDROPERM® T, 0.5 g/l Acetic Acid and 2 g/l IMACOL® ACA was added to the split pocket machine. The bath was heated to 175° F., hold at 175° F. for 45 minutes. The liquor was drained from the split pocket machine, and refilled with water at approximately 120° F. 1 g/l HYDROPERM® RPU was added and Hold 5 minutes at 120° F. The bath was then drained, the water was extracted and mops were dried. A polyester/cotton mop having a very good oil and grease release were obtained.

### Description of Test Method

Two 5-10 gram samples were cut from a mop. The mop samples were weighed and the weight was recorded. One sample was treated by one of the methods described above and a control sample remained untreated as taken from the commercial packaging.

A fixed amount of oil was applied to the mop samples.

(Approximately 3 grams.)

The mop samples were immersed in a 500 ml cleaning solution at room temperature. (The cleaning solution contained approximately 2 ounces of KAY™ KADET™ Quarry Tile Floor Cleaner diluted to 4 gallons with tap water.)

The water was wrung from the mop samples by hand.

The mop samples were immersed in a fresh 500 ml cleaning solution at room temperature.

The water was wrung from the mop samples by hand.

The mop samples were immersed in a fresh 500 ml cleaning solution at room temperature.

The water was wrung from the mop samples by hand.

The mop samples were dried until constant weight was obtained.

The mop samples were weighed and the weights were recorded.

The mop sample weights before and after were used to calculate percentage of oil retention for the treated and untreated mop samples.

TABLE 1
Results for Cotton Yarn

| | i. Percentage of Oil Retention | | | | | | | | |
|---|---|---|---|---|---|---|---|---|---|
| No. of Uses | 1 | 2 | 3 | 4 | 5 | 10 | 15 | 20 | Total |
| Example 3 | 26 | 12 | 2 | 12 | 8 | 17 | 37 | 8 | 122 |
| Untreated Cotton | 41 | 35 | 4 | 8 | 17 | 13 | 34 | 18 | 169 |

TABLE 2
Results for Polyester/Cotton Yarn

| | i. Percentage of Oil Retention | | | | | | | | |
|---|---|---|---|---|---|---|---|---|---|
| No. of Uses | 1 | 2 | 3 | 4 | 5 | 10 | 15 | 20 | Total |
| Example 2 | 30 | 13 | 3 | 5 | 13 | 12 | 32 | 9 | 117 |
| Untreated Poly/Cotton | 43 | 31 | 10 | 11 | 11 | 29 | 30 | 20 | 185 |

Changes or modifications in the specifically described embodiments can be carried out without departing from the principles of the invention, which is intended to be limited only by the scope of the appended claims as interpreted according to the principles of patent law including the doctrine of equivalents.

The embodiments of the invention in which an exclusive property or privilege is claimed are defined as follows:

1. A treatment composition comprising at least one hydrophilic polyester copolymer, and at least one hydrophilic reactive polyurethane.

2. A treatment composition according to claim 1, wherein the at least one hydrophilic polyester copolymer is a polyester copolymer with repeating segments of ethylene terephthalate units containing 10-50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the polymeric compound is between 2:1 and 6:1.

3. A treatment composition comprising at least one fluorochemical, and at least one hydrophilic reactive polyurethane.

4. A treatment composition as claimed in claim 1, wherein the at least one hydrophilic reactive polyurethane is based on polyoxyethylene segment containing polyols or polyamines or mixture of them and polyisocyanates, with at least one blocked isocyate group per molecule, preferably based on polyoxyethylene segment containing polyols and aliphatic polyisocyanate, wherein the hydrophilic reactive polyurethane has a molecular weight from 2,000 to 200,000.

5. A treatment composition as claimed in claim 1, wherein the at least one hydrophilic reactive polyurethane has a molecular weight from 2,000 to 20,000.

6. A treatment composition as claimed in claim 1, wherein the at least one hydrophilic polyester copolymer is present in amount of from 5 percent to 10 percent, based on the weight of the treatment composition.

7. A treatment composition as claimed in claim 1, wherein the at least one hydrophilic reactive polyurethane is present in amount of from 0.75 percent to 1.25 percent, based on the weight of the treatment composition.

8. A process for treating a textile fiber comprising the step of applying a treatment composition to the textile fiber, wherein the treatment composition includes at least one hydrophilic polyester copolymer, and at least one hydrophilic reactive polyurethane.

9. The process as claimed in claim 8, wherein the at least one hydrophilic copolymer is a polyester copolymer with repeating segments of ethylene terephthalate units containing 10-50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the polymeric compound is between 2:1 and 6:1.

10. A process according to claim 8, wherein the textile fiber is selected from the group consisting of; synthetic fibers, and composites of synthetic fibers with cellulosic fibers.

11. A process according to claim 8, wherein the textile fiber is polyester, or a mixture of polyester and cotton.

12. Textile fibers treated in accordance with the process of claim 8.

13. A mop comprising textile fibers according to claim 12.

14. A garment comprising textile fibers according to claim 12.

15. A cleaning rag comprising textile fibers according to claim 12.

16. A shop towel comprising textile fibers according to claim 12.

17. A process according to claim 8, wherein the applying step takes place by a batch or an exhaust process.

18. A process according to claim 8, wherein the applying step takes place by a continuous process.

19. A process for treating a textile fiber comprising the step of applying a treatment composition to the textile fiber, wherein the treatment composition includes at least one fluorochemical copolymer, and at least one hydrophilic reactive polyurethane.

20. A textile material treated by the process according to claim 19.

21. A treatment composition as claimed in claim 3, wherein the at least one hydrophilic reactive polyurethane is based on polyoxyethylene segment containing polyols or polyamines or mixture of them and polyisocyanates, with at least one blocked isocyate group per molecule, preferably based on polyoxyethylene segment containing polyols and aliphatic polyisocyanate, wherein the hydrophilic reactive polyurethane has a molecular weight from 2,000 to 200,000.

22. A treatment composition as claimed in claim 21, wherein the at least one hydrophilic reactive polyurethane has a molecular weight from 2,000 to 20,000.

23. A treatment composition as claimed in claim 3, wherein the at least one hydrophilic reactive polyurethane is present in amount of from 0.75 percent to 1.25 percent, based on the weight of the treatment composition.

24. Textile fibers treated in accordance with the process of claim 19.

25. A mop comprising textile fibers according to claim 24.

26. A garment comprising textile fibers according to claim 24.

27. A cleaning rag comprising textile fibers according to claim 24.

28. A shop towel comprising textile fibers according to claim 24.

29. A process according to claim 19, wherein the applying step takes place by a batch or an exhaust process.

30. A process according to claim 19, wherein the applying step takes place by a continuous process.
